(19) United States
(12) Patent Application Publication
(10) Pub. No.: US 2019/0323169 A1
(43) Pub. Date: Oct. 24, 2019

(54) Process for producing flame-resistant synthetic fibres from textile waste, flame-resistant synthetic fibres and their use

(71) Applicant: VISCOSE FASER GMBH, St. Pölten (AT)

(72) Inventors: Bernhard MÜLLER, Baden (AT); Enrique HERRERO ACERO, Wien (AT); Georg Maximilian GÜBITZ, Hart bei Graz (AT)

(21) Appl. No.: 16/311,618

(22) PCT Filed: Jun. 19, 2017
(86) PCT No.: PCT/EP2017/000708

§ 371 Date: Dec. 19, 2018

(30) Foreign Application Priority Data
Jun. 20, 2016 (EP) 16001378.5

(51) Int. Cl. D06M 16/00; C08J 11/10

(52) U.S. Cl. CPC D06M 16/003; A41D 31/08; C08J 11/105

(57) ABSTRACT

Process for producing flame-resistant synthetic fibres from textile waste, flame-resistant synthetic fibres and their use. The invention concerns a process for producing flame-resistant synthetic fibres from textile fabrics, which contain at least a proportion of flame-resistant synthetic fibres and at least a proportion of enzymatically hydrolysable fibres, in which the hydrolysable fibre proportion is dissolved by an enzymatic treatment

### CROSS REFERENCE TO RELATED APPLICATION

The present application is a 35 U.S.C. § 371 national phase entry application of, and claims priority to, International Patent Application No. PCT/EP2017/000708, filed Jun. 19, 2017, which claims priority to European Patent Application No. EP 16001378.5, filed Jun. 20, 2016, the disclosures of which are hereby incorporated by reference in their entirety for all purposes.

### BACKGROUND

The invention concerns a process for producing flame-resistant synthetic fibres from textile fabrics which contain at least a proportion of flame-resistant synthetic fibres and at least a proportion of enzymatically hydrolysable fibres in which the hydrolysable fibre proportion is dissolved by means of an enzymatic treatment.

Furthermore, with such a process, the invention concerns flame-resistant synthetic fibres produced from textile waste and the use of the fibres produced with such a process for the production of textile fabrics.

In particular, flame-resistant synthetic fibres are used in high-performance applications such as in personal protective equipment (PPE) as well as in structural engineering and building construction and underground engineering. At the same time “synthetic fibres” are generally taken to mean fibres made from 2 synthetic polymers, particularly mineral oil-based polymers. In addition to their fire resistance, they also typically have high strengths of greater than 20 cN/tex in the conditioned state (under standard conditions at 20° C. ambient temperature and 65% humidity). Fibres belonging to this category consist predominantly of aromatic polyamides (aramids) and/or polyimides and are known to the person skilled in the art under brand names such as Nomex®, Kevlar®, Twaron®, Conex®, Euramid®, Bluestar, PBI, Arselon® or Kermel®. According to the type of fibre length, a distinction is made between filaments and long and short staple fibres, as well as ultra-short fibres with a length of under 5 mm, for example in in form of aramid papers.

In addition to their positive properties such as flame and heat resistance, plus high specific strength, the specified synthetic fibres also have disadvantages such as e.g. lack of wearing comfort or lack of colourability due to mostly chemically inert fibre surfaces. Thus the combination of synthetic fibres with fibres with good moisture management and high intrinsic wearing comfort such as cotton, wool or viscose and rayon in a blended textile offers a synergistic combination of advantages such as for example flame resistance, high tensile strength and high wearing comfort. An improved colourability likewise plays a role. In the case of personal protective equipment, be it in the military or the civilian field, staple fibres with a length less than 150 mm and greater than 30 mm are mainly used. The fibre length used is dependent upon the spinning method and the desired mixing partner.

For personal protective clothing, for example in the firefighting or military field, low flammability is of special importance. The “Limiting Oxygen Index” (LOI) is used as a measurement for the flammability of fibres. The Limiting Oxygen Index represents the minimum oxygen concentration (in percent) in a nitrogen-oxygen mixture at which the combustion of a test specimen made of the fibres to be tested is still sustained. Fibres with an LOI greater than or equal to 25 are described as “flame-retardant”. Current standards and standard test conditions to determine the LOI are known to the person skilled in the art. The standard ASTM D2863 can be mentioned as an example of these.

Aromatic polyamides such as meta-aramids para-aramids as flame-resistant synthetic fibres and permanent flame-retardant viscose as fibres of natural origin, for example, represent typical fibre combinations in blended fabrics for personal protective clothing. A fibre combination of, for example, three different fibre types, such as for example aramid-nylon-viscose (known under the brand name “Defender™ M”) or polybenzimidazole (PBi)-viscose-aramid (brand name “PBI TRIGUARD™”) is also possible. In many instances the viscose fibres or the blended textile also contain pigments or flame-retardant pigments.

In this context the term “textile waste” is taken to mean on the one hand production waste or reject fractions incurred in the production of personal protective clothing and, on the other, post-consumer materials, i.e. used or worn personal protective clothing to be disposed of. Due to the previously described complex textile structure of such textile waste or the different materials processed into personal protective clothing, in most instances only disposal by dumping the textile waste took place previously instead of a recycling of PPE.

The fabric's flame-resistant synthetic fibre proportion represents a resource, whose reclamation from textile waste and re-use in textiles is very beneficial for economic reasons. The manufacturing processes for flame-resistant synthetic fibres known to the person skilled in the art are very energy intensive and based upon toxic solvents which require a special spinning or plant technology. Due to the high manufacturing costs and the high demand, such fibres typically tend towards a high price sector. Hence a process for producing them from textile waste, which does not substantially alter the average fibre length and the fibre length distribution of the synthetic fibres, particularly from staple fibre mixtures, during reclamation would be an appreciable additional benefit both from an economic and an ecological point of view.

To date accrued textile fabrics containing aramid fibres such as fabrics for example were typically processed into shredded fibres on conventional shredding equipment for disposal. In this instance it proves to be disadvantageous that due to the mechanical shredding process, the average fibre length of the recycled aramid fibres is appreciably shortened, on account of which although they are still suitable for use in the non-woven material sector or the fibre composite sector, they are nevertheless barely suitable for re-use in the textile sector. EP1378595B1 does indeed disclose a process for manufacturing aramid fibres which can be re-used in the textile sector, in which the textiles containing aramid are shredded in a mechanical chopping process which does not affect the fibre length. However, this process can only be used for pure or pre-sorted aramid fibres or textiles. The treatment of blended fabrics containing aramid using this process, in which viscose is also contained for example, would not result in the reclamation of pure aramid fibres.

### DETAILED DESCRIPTION

The invention is therefore based on the task of avoiding the disadvantages described above.

To solve this task the invention foresees a process for producing flame-resistant synthetic fibres with a Limiting Oxygen Index greater than or equal to 25, preferably greater than or equal to 28 from textile fabrics, which contain at least a proportion of flame-resistant synthetic fibres and at least a proportion of enzymatically hydrolysable fibres, in which the textile fabric is treated using a solution containing an enzyme to dissolve the hydrolysable fibre proportion and a separation subsequently takes place of the remaining proportion of the textile fabric consisting of synthetic fibres from the reaction mixture containing the enzyme and hydrolysed fibre breakdown products. In this manner flame-resistant synthetic fibres can be produced from textile fabrics such as woven textiles, knitted fabrics, twisted yarns, knitted and crocheted goods or non-woven fabrics as easily as possible and with no fundamental effect on the fibre length. The textile fabrics originate for example from used textiles or old clothing, but also from waste or reject products from textile production or other industrial uses in which textile fabrics are used. The synthetic fibres recovered in this manner can be used once again for the manufacture of textile fabrics for new textiles.

It is generally known that cellulosic fibres from for example reclaimed cellulose or viscose can be decomposed by enzyme catalysed hydrolysis Shojaei et al., Appl. Biochem. Biotechnol. (2012) 166:744-52). In the enzymatic hydrolysis more than 85% of the cellulosic proportion of the fibres is preferably broken down into glucose and particularly preferably more than 90% and the fibre matrix completely broken down.

The process in accordance with the invention builds on this principle. Textile waste, for example protective clothing for disposal, whose material composition consists of for example a blended textile made of flame-resistant synthetic fibres such as for example meta-aramid or para-aramid fibres and hydrolysable fibres such as for example viscose fibres, in particular flame-retardant modal fibres, are used as primary materials.

In this instance the total proportion of flame-resistant synthetic fibres in the textile fabric amounts to more than or equal to 5 weight percent, preferably greater than or equal to 15 weight percent, and particularly preferably greater than or equal to 25 weight percent. The total proportion of enzymatically hydrolysable fibres in the textile fabric is more than or equal to 5 weight percent, preferably greater than or equal to 30 weight percent, and particularly preferably more than or equal to 50 weight percent. In the instance of 5 mixed used textile fractions, which are characterised for example by different colours or material compositions, an optional pre-sorting of the textile waste is recommended to obtain flame-resistant synthetic fibres as homogenous and of the same colour as possible from the subsequent treatment. As an option the textile waste can be coarsely shredded or chopped mechanically before the subsequent treatment, but without appreciably damaging or shortening the predominant part of the fibres themselves. In a subsequent washing stage solid materials such as dirt and dust are removed from the worn items of clothing, in which an aqueous solution is preferably used. If required, the solution can also contain bleaching or reducing agent to remove potentially disruptive colourants from the textile fabric beforehand. Alternatively a pre-activation and/or soaking of the hydrolysable fibre proportion, which can make the fibres more accessible for the subsequent enzymatic treatment can take place in the same or a separate washing stage by the addition of NaOH, for example.

The treatment of the textile fabrics by means of a solution, preferably an aqueous solution, containing an enzyme typically takes place in a batch process. In the event of an aqueous solution being used, its pH value in this instance shall be between 4 and 6 under buffered conditions and shall be aligned with the necessary reaction conditions required for the relevant enzyme. The textile fabrics are vigorously mixed with the aqueous solution by stirring, agitation or similar processes and mixed with the enzymes. In the case of cellulosic fibres, cellulases containing endoglucanses and or exoglucanses, and in particular B-glucosidase too, are preferably used as enzymes. The enzymatic treatment takes place at a temperature of less than 100° C., preferably of less than 80° C., and particularly preferably of less than 60° C. By way of example, a treatment temperature of 50° C. has proved to be effective as regards particularly short reaction times.

The enzymes used and their substrate specificity must preferably be chosen in such a manner that they are capable of dissolving more than 90% of the hydrolysable fibre proportion and preferably more than 99%, but on the other hand of not changing the fire-resistant synthetic fibres macroscopically. In this instance a dissolution rate of for example more than 99% means that a residual proportion of less than 1% is present on the synthetic fibres produced with the process in accordance with the invention after carrying out the process. Mixtures of various enzymes can also be used.

Due to the enzymatic hydrolysis or dissolution of the cellulosic fibre proportion, there remains a textile structure of pure synthetic fibres which can be separated from the reaction mixture which still contains inter alia enzymes, buffer salts plus glucose and possibly other cellulosic decomposition products. The separation of the residual textile structure, which—depending on the type of base material—can be present in the form of individual fibres, a fibre bundle or nevertheless as a laminar structure, takes place for example with a filtration stop familiar to the person skilled in the art, in which the textile structure remains in the filter whilst the aqueous reaction mixture forms the filtrate. In the case of treating homogenous fibre mixtures, a laminar textile structure was obtained which surprisingly has sufficient mechanical strength so that—as an alternative to filtration—it can also be separated from the reaction mixture by simply lifting or pulling it out of the treatment solution. As an option the laminar structure can then be dried.

Solid additives such as pigments, which are optionally either spun into the hydrolysable fibres or fixed to their surface, are likewise released by the enzymatic dissolution of the hydrolysable fibre proportion and can be reclaimed.

The pigments can be of various kinds and functionalities, for example flame-retardant pigments, colour pigments, luminescent pigments, dulling pigments, pigments which absorb or reflect infra-red or X-ray radiation or even waxy phase-change materials and applied ion exchangers contained as pigments. The pigments can also be present in the form of a pigment mixture consisting of different pigments, for example a flame-retardant organophosphorus pigments and a colourant and/or luminescent pigment. By way of example, the use of such pigments is described in AT 513426 A1, AT 508687 A1, AT 511638 A1, AT 509801 A1 or AT 510229 B1.

In cases where the textile fabric used as the base material contains hydrolysable fibre components containing pigment, separation of the pigments occurs after the enzymatic hydrolysis, preferably after the separation stage for separating the textile fabric's residual synthetic fibre proportion. After separation of the textile structure by filtration or mechanical lifting out, the pigment particles in the residual reaction solution can be reclaimed. Alternatively the pigments can also be continuously separated from the reaction solution during the enzymatic hydrolysis process. The separation of the pigments can be geared to their physical characteristics such as particle size or density. Separation of the pigment particles from this solution can take place for example by a filtration stage known to the person skilled in the art, in which the filtration device has such a pore size that the pigment particles are retained in the filter and form the filter cake, or alternatively by decanting off the overlying reaction liquid from the pigment particles that have sunk to the bottom. Centrifuging the pigments must preferably be mentioned as a further separation possibility. The pigments can optionally be subject to a washing, bleaching or drying treatment before re-use, in which these treatment stages can be applied singly or in combination.

Any metal or plastic appliqué items such as for example studs or zip fasteners applied to the textile fabrics and released by the enzymatic treatment can likewise be separated in this manner.

Before its separation into individual fibres, residual proportion of the textile fabric containing the fire-resistant synthetic fibres can, as an option, be subjected to a cleaning stage for the removal by oxidation or reduction of the dyestuffs or sundry impurities such as for example a waterproofing or antimicrobial finish remaining on the synthetic fibres. In this instance the textile fabric is subjected to an oxidative or reductive fibre cleaning process in an aqueous solution which is known to the person skilled in the art and used in the textile sector, in which the oxidation takes place for example with a mixture of sodium hydroxide, hydrogen peroxide (35%) and a bleaching additive (for example Contavan® ARL), and the reduction for example with an alkaline sodium hydrosulphite solution. Alternatively, impurities can also be removed from the fibres with non-aqueous solvents, in which it must be taken into account that these solvents themselves do not partially dissolve or dissolve the fibres. For this purpose solvents or solvent mixtures with a dielectric constant smaller than 65 at 25° C. are particularly suited (see also CRC Handbook of Chemistry and Physics, 92nd edition (2011-2012), CRC Press, pages 6-187 et seq.).

Depending on the base material, the reclaimed synthetic fibre proportion can be present in the form of individual fibres or a fibre bundle or even a laminar structure. In the final instance the laminar structure produced can be recycled once again into the individual synthetic fibres in a subsequent mechanical separation process with no noteworthy shortening of the fibre length. This takes place for example by the laminar structure being separated into its fibre components by means of a blunt, rotating striking element—as is known from DE 19900770 A1.

The flame-resistant synthetic fibres reclaimed with the process in accordance with the invention have a difference in their average fibre length of less than 30%, preferably less than 15%, and particularly preferably less than 10% compared with primary fibres with the same chemical structure and can be re-used to manufacture woven textiles or other textile fabrics. In this context the term “primary fibres” means fibres which have been newly produced.

In the case of cellulosic fibres, the enzymes or enzyme mixture contained in the remaining reaction mixture can be separated from the occurring glucose and other low-molecular fibre breakdown products produced by the hydrolysis with for example an ultrafiltration process and optional subsequent nanofiltration process, as described in Qi et al., Bioresour. Technol. 2012 January; 104:466-72, and recycled once again for the hydrolysis treatment of textile waste.

The accrued glucose can be used for producing bioethanol, for example. It can also be used as a base material for the synthesis of other resources that can be produced by fermentation. Its use as a feedstock in biogas plants, particularly in a biogas plant connected directly to the fibre reclamation plant, offers an additional possibility for use.

Between the individual process steps the remaining proportion of the textile fabric and the fibres contained in it can optionally be subjected in each case to a washing treatment with water or other suitable solvents that is self-evident to the person skilled in the art to remove base or reaction products.

The following example shows one embodiment of the process in accordance with the invention.

### Example 1

10 g of a double face mesh knitted fabric with a specific weight of 187 g/m² consisting of an outer material made of flame-retardant viscose (Viscont FR 110 f46 S90, containing 18 weight % Exolit 5060 as a flame-retardant pigment) and an inner material made of a staple fibre mixture (200 dtex) of 70% viscose and 30% aramid were placed in 49 ml of an aqueous buffer solution (citric acid 50 mmol, pH=4.8). 1 ml Cellic® CTec 3 (Novozymes) was then added as an enzyme and agitated at 50° C. and 100 rpm for 24 hours. A complete dissolution of the viscose fibre proportion had occurred after 24 hours; the remaining aramid fibre proportion was present in the form of a laminar structure and could be removed by withdrawal from the reaction mixture. The flame-retardant pigments released were present in a colloidal form and were separated from the reaction solution by gravity filtration.

The objective invention is not restricted to aramid fibres or sundry aromatic polyamides as flame-resistant synthetic fibres to be produced. The process in accordance with the invention is in principle likewise suitable for producing sundry flame-resistant synthetic fibres from for example polybenzimidazole (PBl), p-phenyl-2,6-benzobisoxazole (PBO), polyimide, polyimide amide, Modacryl and further flame-retarded polyamide fibres, flame-retarded acrylic fibres, melamine fibres or flame-retarded elastane and mixtures of these fibres. The synthetic fibre proportion contained in the base material can optionally also consist of a fibre mixture, for example of para- and meta-aramid fibres. In this case the synthetic fibre mixture can also be reclaimed with this process.

The fibres that can be hydrolysed with the process in accordance with the invention are not restricted solely to cellulosic fibres such as reclaimed cellulose fibres, carbamate fibres, lyocell fibres and fibres spun from ionic liquids or cotton fibres. Hydrolysing other enzymatically hydrolysable fibre types, such as for example fibres made of polyester or polyamide 6 or polyamide 6.6 (nylon) in the process in accordance with the invention is likewise conceivable. In the case of polyamide 6 or polyamide 6.6, nylon hydrolases for example are used as enzymes instead of cellulases. Furthermore, there is also the possibility of hydrolytically degrading a textile fabric containing at least two different types of hydrolysable fibres, such as for example viscose and nylon together, i.e. at the same time in a suitable reactor by means of a suitable enzyme mixture made of cellulases and nylon-hydrolysing enzymes. A serial hydrolysis, for example the hydrolysis of the cellulosic fibres initially and then the hydrolysis of the nylon fibres in a separate second stage is equally conceivable. As an alternative to an enzymatic hydrolysis of fibres made for example of polyester or polyamide 6 or polyamide 6.6 (nylon), their removal by a suitable solvent or solvent system such as for example formic acid can be considered in the case of nylon.

The invention is not restricted to the individual characteristics shown in the embodiment. In fact, the characteristics of the claims below and the above specification can be fundamental on their own or in combination for the invention's implementation in its various embodiments.

1. A process for producing flame-resistant synthetic fibres with a Limiting Oxygen Index greater than or equal to 25, preferably greater than or equal to 28, from textile fabrics, which contain at least a proportion of flame-resistant synthetic fibres and at least a proportion of enzymatically hydrolysable fibres, characterised in that the textile fabric is treated using a solution containing an enzyme to dissolve the hydrolysable fibre proportion and a separation subsequently takes places of the remaining proportion of the textile fabric made up of synthetic fibres from the reaction mixture containing enzymes and hydrolysed fibre decomposition products.

2. The process in accordance with claim 1, characterised in that the textile fabrics are fabrics, knitted fabrics, twines, crocheted fabrics or non-crimp fabrics.

3. The process in accordance with claim 1, characterised in that the total proportion of flame-resistant synthetic fibres in the textile fabric is greater than or equal to 5 weight percent, preferably greater than or equal to 15 weight percent, and particularly preferably greater than or equal to 25 weight percent.

4. The process in accordance with claim 1, characterised in that the total proportion of enzymatically hydrolysable fibres in the textile fabric is greater than or equal to 5 weight percent, preferably greater than or equal to 30 weight percent, and particularly preferably greater than or equal to 50 weight percent.

5. The process in accordance with claim 1, characterised in that the hydrolysable fibre proportion contains cellulosic fibres, preferably made from reclaimed cellulose.

6. The process in accordance with claim 1, characterised in that the hydrolysable fibre proportion contains fibres made of polyamide 6 or polyamide 6.6.

7. The process in accordance with claim 1, characterised in that the enzymatic treatment of the textile fabric takes place at a temperature of less than 100° C., preferably less than 80° C., and more preferably of less than 60° C.

8. The process in accordance with claim 1, characterised in that after separation of the proportion of the textile fabric consisting of synthetic fibres, further solid materials contained in the fibres, in particular fire-retardant pigments or pigments can be separated.

9. The process in accordance with claim 1, characterised in that the proportion of the textile fabric consisting of synthetic fibres is treated with an oxidant to remove colour and/or impurities after its separation from the reaction mixture.

10. The process in accordance with claim 1, characterised in that the proportion of the textile fabric consisting of synthetic fibres can be treated with a reducing to remove colour and/or impurities after its separation from the reaction mixture.

11. The process in accordance with claim 1, characterised in that the separated residual proportion of the textile fabric in which individual synthetic fibres are unravelled.

12. The process in accordance with claim 1, characterised in that after treatment of the textile fabric, the enzymes are separated from the reaction mixture and recycled for enzymatic treatment.

13. Flame-resistant synthetic fibres produced from textile fabrics with a Limiting Oxygen Index greater than or equal to 25, preferably greater than or equal to 28, produced with a process in accordance with claim 1.

14. Synthetic fibres in accordance with claim 13, characterised in that the average fibre length of the synthetic fibres produced differs by less than 30%, preferably less than 15%, and particularly preferably by less than 10% compared with the average fibre length of primary fibres with the same chemical structure.

15. Use of flame-resistant synthetic fibres produced by a process in accordance with claim 1 from textile fabrics with an Limiting Oxygen Index greater than or equal to 25, preferably greater than or equal to 28, for the manufacture of textile fabrics.
